(19) United States
(12) Patent Application Publication
(10) Pub. No.: US 2023/0373622 A1
(43) Pub. Date: Nov. 23, 2023

(54) METHOD AND SYSTEM FOR DETECTION AND RECOVERY OF BLOCKED AIR FLOW

(71) Applicant: Johnson Controls Tyco IP Holdings LLP, Milwaukee, WI (US)

(72) Inventors: Jason M. Ouellette, Sterling, MA (US); Glenn HOLTON, Braintree, MA (US)

(21) Appl. No.: 17/751,221

(22) Filed: May 23, 2022

(51) Int. Cl. B64C 39/02; B64C 11/46

(52) U.S. Cl. CPC B64C 39/024; B64C 11/46; B64C 2201/162; B64C 2201/108

(57) ABSTRACT

A method for detection of air flow disruption includes monitoring air flow generated by an air propulsion system to detect one or more air flow anomalies indicating potentially blocked air flow. In response to detecting the one or more air flow anomalies, the airflow generated by the air propulsion system may be automatically reversed or temporarily stopped. A determination may be made whether the one or more detected air flow anomalies are resolved by the reversed or stopped air flow. The airflow generated by the air propulsion system prior to the detection of the one or more air flow anomalies may be resumed, in response to determining that the one or more air flow anomalies are resolved.

### TECHNICAL FIELD

The present invention relates generally to the field of air flow systems, such as but not limited to those in unmanned, autonomous vehicles, and more specifically, to methods and systems for detection and recovery of blocked air flow.

### BACKGROUND

In recent years, Unmanned Aerial Vehicles (UAVs) have been developed and put into use in different applications. Besides UAVs, such as large drones used in military applications, smaller consumer-level UAVs have recently become more popular in civilian applications due to their ease of use. For example, smaller self-stabilizing UAVs are now commonly used by operators with little or no flight training, similar to how small-scale airplanes and helicopters have been used by skilled hobbyists for some time.

While there are many beneficial uses of UAVs, they also have many drawbacks. For example, UAV's propeller blades typically generate downward airflow, or prop wash. Such airflow may generate debris in the air, such as, but not limited to papers. The suction from the propeller blades often pulls the debris into an air intake or inlet area and may cut off the airflow. Should UAVs lose the air flow while in flight, the vehicles may descend very fast and crash. During such cases, descent velocity and trajectory are also uncontrolled. Further, in some cases, the UAV's rotor blades are exposed and such uncontrolled flight can potentially cause hazardous damage to the environment, e.g., nearby infrastructures and/or people.

Thus, there is a need in the field for improvements in the operation of UAVs.

### SUMMARY

The following presents a simplified summary of one or more implementations of the present disclosure in order to provide a basic understanding of such implementations. This summary is not an extensive overview of all contemplated implementations, and is intended to neither identify key or critical elements of all implementations nor delineate the scope of any or all implementations. Its sole purpose is to present some concepts of one or more implementations of the present disclosure in a simplified form as a prelude to the more detailed description that is presented later.

In accordance with one aspect, there is provided a method for detection of air flow disruption based on changes in air flow. One example implementation of detection of air flow disruption relates to UAVs. Such detection of air flow disruption may be used to notify a UAV controller in order to take a corrective action to prevent uncontrolled descents/crashes of UAVs. In some aspects, the air flow disruption detection component may temporarily “stop” the drone by temporarily activating an onboard “stop” switch, for example. When the on board “stop” switch is activated, the “stop” switch may temporarily stop the drone, that is, control a lift mechanism of the drone, e.g., commanding motors of the drone to brake (e.g., commanding the motors to free spin, to actively brake, or substituting a throttle signal to the lift mechanism with a zero throttle command) until the debris are cleared and the UAV's air flow is restored.

One example implementation relates to method for detection of blocked air flow. One aspect of the method includes monitoring air flow generated by an air propulsion system to detect one or more air flow anomalies indicating potentially blocked air flow. In response to detecting the one or more air flow anomalies, the airflow generated by the air propulsion system may be automatically reversed or temporarily stopped. A determination may be made whether the one or more detected air flow anomalies are resolved by the reversed or stopped air flow. The airflow generated by the air propulsion system prior to the detection of the one or more air flow anomalies may be resumed, in response to determining that the one or more air flow anomalies are resolved.

Additional advantages and novel features relating to implementations of the present disclosure will be set forth in part in the description that follows, and in part will become more apparent to those skilled in the art upon examination of the following or upon learning by practice thereof.

### DESCRIPTION OF THE FIGURES

The novel features believed to be characteristic of the disclosure are set forth in the appended claims. In the descriptions that follow, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objects and advances thereof, will be best understood by reference to the following detailed description of illustrative aspects of the disclosure when read in conjunction with the accompanying drawings, wherein:

FIG. 1 is a block diagram of components of a UAV device configured to detect an air flow anomaly, in accordance with aspects of the present disclosure;

FIG. 2 is a diagrammatic view of a flying UAV device, such as drone, surrounded by debris, in accordance with aspects of the present disclosure;

FIG. 3 is a diagrammatic view of a flying UAV device, such as drone, having a detected air flow anomaly, in accordance with aspects of the present disclosure;

FIG. 4 is a diagrammatic view, similar to FIG. 3, but with the drone taking a corrective action, in response to detecting the air flow anomaly, to prevent uncontrolled descent in accordance with aspects of the present disclosure;

FIG. 5 is a diagrammatic view, similar to FIGS. 3 and 4, of the drone automatically returning to a corrected flight position after taking the corrective action, in accordance with aspects of the present disclosure;

FIG. 6 is a partial cross-sectional view through a variable pitch fan configured to detect an air flow anomaly, such as via a blocked air flow detection mechanism, in accordance with aspects of the present disclosure;

FIG. 7 is a flowchart of an example method for detection of blocked air flow, in accordance with aspects of the present disclosure; and

FIG. 8 is a block diagram of various hardware components and other features of an example of the blocked air flow detection system in accordance with aspects of the present disclosure.

### DETAILED DESCRIPTION

According to one aspect of the present disclosure, a method for detection of blocked air flow advantageously combines information provided by a variety of sensors to perform automatic detection and recovery from blocked air flow generated by an air propulsion system. In one aspect, the air propulsion system may be a component of a UAV, such as a drone. Light Detection And Ranging (LIDAR), computer vision, infra-red, near infra-red (NIR) and other sensors may be used to detect obstacles preventing normal air flow. Information provided by a panel of integrated sensors of a UAV may be utilized by a flight controller to navigate the UAV to safety by resolving the detected air flow anomalies.

It will be readily understood that variants of an air propulsion system such as described herein may be utilized in various types of fans, such as ducted fans, including components of a Heating Ventilating and Air Conditioning (HVAC) system.

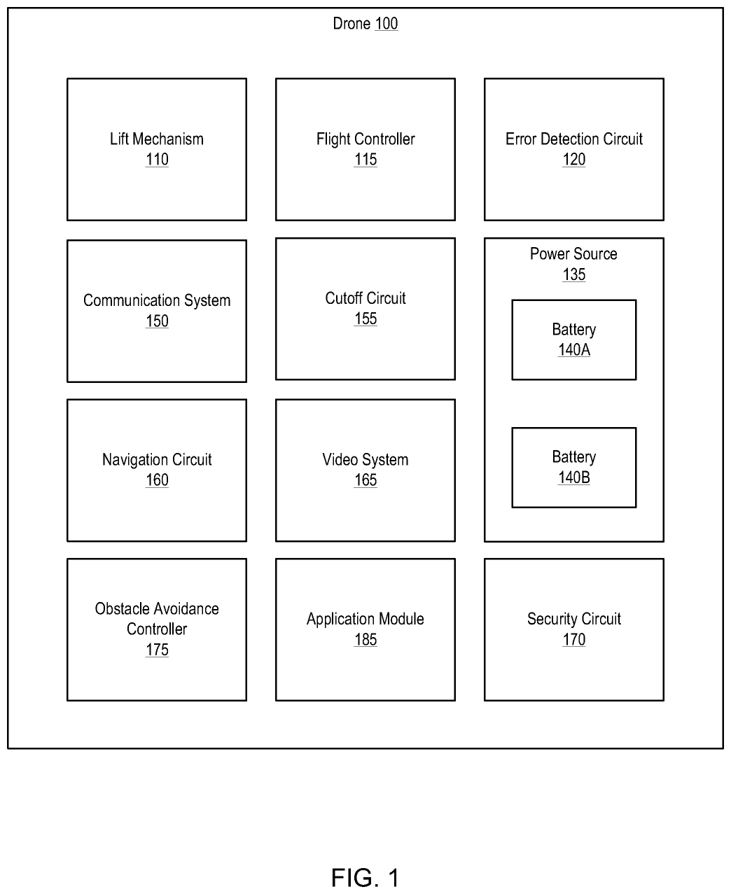

FIG. 1 is a block diagram illustrating components of a UAV, such as a drone 100, in accordance with aspects of the present disclosure. The drone 100 may include a lift mechanism 110 that may be configured to lift, propel, and/or steer the drone 100. The lift mechanism 110 may form part or all of an air propulsion system. Examples of the lift mechanism 110 may include one or more of motors and rotors of a rotorcraft, one or more motors and propellers, wings and rotors/propellers/motors or thrust engines of fixed wing aircraft, lighter than air containers of aerostats (lighter-than-air aircrafts), and any hybrid combination thereof. The rotorcraft may utilize any number of rotor blades, also referred to as propellers, to provide lift, thrust, and/or steering throughout the duration of flight of the drone 100. Common examples of rotorcraft include helicopters which primarily use a single variable pitch rotor blade, and multi-rotors which use two or more typically fixed-pitch rotor blades to generate lift and thrust, and control altitude. In one example, for instance, the drone 100 may include four rotor blades, such as one at each corner, which may be referred to as a quadcopter or quadrotor. In some examples, adjacent ones of the four rotor blades may rotate in opposite directions, while opposing ones of the four rotor blades may rotate in a same direction opposite the adjacent ones. In some cases, the rotor blades may be positioned within a duct, while in other cases, the rotor blades may be unducted and/or protected by a guard rail adjacent spaced apart from a tip of the rotor(s) around all or a portion of a circumference of the rotor(s). In another optional or additional aspect, the one or more rotors may be contained within a cage-like structure.

A fixed wing aircraft may generate lift through the wings based on the forward velocity of the aircraft, usually generated by thrust. The forward velocity may be generated using rockets, propellers and/or various types of jet engines. The flight control surfaces, often on the wings, allow changes in altitude. The forward thrust propulsion may be generated using propeller engines. The methods of powering these engines may include electricity (generated on the go through solar panels or stored in batteries) and hydrogen cells.

Hybrid combinations may include the tilt wing and tiltrotor aircraft which change the tilt of the wing and the rotor respectively in order to allow the aircraft to use the same propulsion engines for vertical take-off and hovering as well as for forward thrust propulsion.

The drone 100 may include a flight controller 115 (also referred to as an auto pilot system) which may be configured to control the drone 100 in flight. The flight controller 115 may be directly responsible for controlling all the mechanisms of flight and/or components of the drone 100 based either on input from a pilot over a remote connection, or from integrated onboard circuitry designed to autonomously control the drone 100. The flight controller 115 may have direct control over an air propulsion system, such as the lift mechanism 110 (e.g., to control thrust, tilt, hovering, climbing, descending, and turning, pitch angle, roll angle, yaw angle) and any flight control surfaces. In an aspect, the lift mechanism 110 may include one or more rotary propellers, for example. The flight controller 115 may control the lift mechanism 110 for taking off the drone 100, flying the drone 100, and/or landing the drone 100. The flight control 115 may control the lift mechanism 110 in various ways, e.g., starting one or more motors of the lift mechanism 110, stopping one or more motors, increasing and/or decreasing the speed of rotation of one or more motors, and performing one or more of the above operations in a specified sequence or pattern among the one or more motors. In some aspects, the flight controller 115 may be programmed, e.g., using onboard logic or circuitry, with some restrictions for the flight of the drone 100. For example, the flight controller 115 may be programmed to keep the drone 100 within a specified altitude, e.g., 400 feet. In another alternative or additional example, the flight controller 115 may be programmed to keep the drone 100 within a specified perimeter. In another alternative or additional example, the flight controller 115 may be programmed to keep the drone 100 moving along a specified path. Further, in some implementations, the flight controller 115 may form part or all of an air propulsion system.

The drone 100 may include an error detection circuit 120 configured to detect errors in operation of the drone 100 and generate a trigger event in response to the error detection. The various types of errors include air flow anomalies (i.e., blockage of air flow to one or more propellers), navigation loss of the drone 100, communication loss with a ground control station, heartbeat loss—lack of heartbeat signal from the auto pilot system or a flight controller 115, power being below a specified threshold or power loss of one or more power sources, impact of the drone 100, gyro error, motor control, geo-fence breach, loss in altitude, sudden drop, inversion, fire, video loss, tilt, and the like. In some aspects, the error detection circuit 120 may be configured to receive a heartbeat signal from the auto pilot system or the flight controller 115, which may indicate that the auto pilot system is functioning as expected, at predefined intervals. If the error detection circuit 120 does not receive the heartbeat signal at the predefined intervals, the error detection circuit 120 may determine that there is a heartbeat loss, which may indicate a problem with the auto pilot system. In some aspects, the error detection circuit 120 may determine an air flow anomaly or a similar error due to debris in the air caused by prop wash, for example.

Occurrence of one or more of these errors may result in a failure of the drone 100. The error detection circuit 120 may then generate a trigger event in response to the detection of the error, which in turn may trigger a recovery action automatically. In some aspects, the error detection circuit 120 may use one or more sensors on board the drone 100 to determine an error (i.e., an air flow anomaly caused by debris in the vicinity of the drone 100). The error detection circuit 120 may analyze the data from these sensors and determine whether an error has occurred.

The drone 100 may include a power source 135 configured to power the drone 100, e.g., the lift mechanism 110 and the error detection circuit 120. In some examples, the power source 135 may include one or more batteries. The power source 135 may include multiple power sources, e.g., a first power storage device 140a, e.g., a battery, for providing power to the lift mechanism 110 and an independent second power storage device 140b, e.g., a battery. for providing power to the error detection circuit 120.

The drone 100 may include a communication system 150 that may facilitate a remote user to communicate with the drone 100, e.g., for steering the drone 100, for issuing any other commands to the drone 100 or receiving information from the drone 100. In some aspects, the remote user may communicate with the drone 100 using a base unit, which can be a hand-held unit, that is capable of transmitting data to and receiving data from the drone 100, e.g., via radio or satellite communication. The communication system 150 may include a two-way radio to communication with the base unit (not shown in FIG. 1) and/or ground control station. For example, the communication system 150 may communicate a status of the error detection circuit 120, e.g., details of detected errors, to the remote operator at the base unit. In some aspects, the communication system 150 may provide diverse, redundant, and persistent communications for command/control of the drone 100. In some aspects, the communication system 150 may include “aviation grade” communications for integration of UAVs within commercial environments and airspace.

The drone 100 may include a cut-off circuit 155 that may control the functioning of the lift mechanism 110 of the drone 100. For example, the cut-off circuit 155 may disable or stop the motors momentarily, in response to detection of an air flow anomaly or a similar error so that detected debris can be cleared automatically. The cut-off circuit 155 may include a “stop” switch, that may be triggered when the error detection circuit 120 detects an air flow anomaly. The “stop” switch may control the lift mechanism 110, e.g., may disable or stop the motors momentarily. For example, the stop-switch may stop or disable the motors temporarily by braking the motors and/or cutting off the power supply to the motors causing the motors to free spin, cutting off the power supply to motors by grounding the signal to the motors, by substituting the throttle signal from the flight controller to the lift mechanism 110, e.g., to the electronic speed controller (ESC) of the lift mechanism 110. In some aspects, the lift mechanism 110 may be disabled momentarily to allow the drone 100 to clear the detected air flow obstacle. Other methods for temporarily disabling the lift mechanism 110 are also possible some of which are described below.

The drone 100 may include a navigation circuit 160 that may facilitate in the navigation of the drone 100. The navigation circuit 160 may have instructions such as a location where the drone 100 is to travel, etc., and may include a global positioning system and/or inertial measurement unit (as discussed below) for steering the drone 100 along a heading or path.

The drone 100 may include a video system 165 that facilitates to capture an image, an audio clip, and/or a video clip of various targets and/or of parts of the drone 100, e.g., to determine a status of blockage of the air propulsion system. In some aspects, the video system 165 may transmit the captured data to a remote user, e.g., in real time. In some aspects, the video system 165 may store the captured data on a storage device installed in the drone 100 or store in a storage device at a remote location defined by the remote user. In some aspects, the video system 165 may include one or more video cameras that provide a video of the drone surrounding area that may be used to detect debris in the air.

The drone 100 may include a security circuit 170 that may facilitate in preventing unauthorized interference with the command and control of the drone, such as hacking of the control datalinks between the drone and the base unit, e.g., Ground Control Station.

The drone 100 may include an obstacle avoidance controller 175 that may facilitates in steering the drone when an obstacle affecting the air flow is detected. In some aspects, the obstacle avoidance controller 175 may detect obstacles automatically using integrated sensors, e.g., air flow, motion, video feed, sonar, radar, Light Detection And Ranging (LIDAR), computer vision, infra-red, near infra-red (NIR), thermal, sonic, microphone, biometric data collection, temperature, humidity sensors of the drone 100, and/or any other types of sensors that may be useful in capturing monitoring data related to obstacle avoidance. These sensors may provide motor inputs, height, pitch, roll, heading, position, altitude, high-precision absolute and relative location, obstacle detection, distance detection, speed control and wind speed. In an aspect, the obstacle avoidance controller 175 may use a logic system that may facilitate in avoiding obstacles and landing the drone at the safest available location or a specified location. For example, the obstacle avoidance controller 175 may communicate with the video system 165 to monitor the environment around the drone 100 and facilitate in landing the drone at the safest available location in the event of the failure of the drone 100. These sensors may be a completely discrete system as part of the obstacle avoidance controller 175 or it may make use of the suite of sensors that are still operable on the drone 100. In another example, the obstacle avoidance controller 175 may be steered manually by an operator from the base unit, e.g., using a live video feed from the drone 100 or directly if the drone 100 is in a line of sight of the operator.

In an aspect, the obstacle avoidance controller 175 may include an inertial measurement unit (IMU). In general, an IMU may include accelerometers, such Xₐ, Yₐ and Zₐ or/and gyroscopes, such as X_{g}, Y_{g} and Z_{g}. Sensors of each type may be oriented along the axes of a reference axis system A_{ref}, such as an orthogonal coordinate system. In this way, the total acceleration may be calculated as the vector sum of the various linear accelerations. Similarly, when gyroscopes are oriented along a system of orthogonal axes, motion with respect to the axes (often described as roll, yaw, and pitch motions) may be measured directly. In general, sensor clusters may also be arranged substantially parallel to the main axes of an axes system. Further, individual sensors may be assembled in several ways in order to make up a sensor cluster.

The drone 100 may be deployed to perform one or more applications, e.g., surveillance of illegal activities to safeguard civil security, anti-poacher operations, forest fire fighting, monitoring flooding storms & hurricanes, traffic monitoring, radiation measurement, searching for missing persons, monitoring harvesting, and the like. The drone 100 may include an application module 185 that may facilitate the drone 100 in performing a specified user-defined application. The application module 185 may include the instructions for the drone 100 to perform the specified user-defined application.

Note that the drone 100 illustrated in FIG. 1 is not restricted to having the above modules. The drone 100 may include lesser number of modules, e.g., functionalities of two modules can be combined into one module. The drone 100 may also include more number of modules, e.g., functionalities performed by a single module can be performed by more than one module, or there may be additional modules that perform other functionalities. Further, the functionality performed by a module described above may be performed by one or more of the other modules as well.

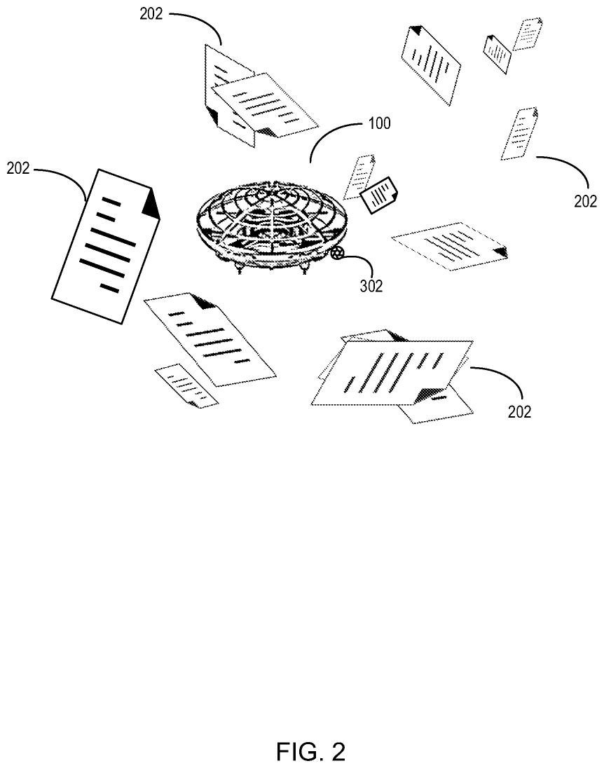

FIG. 2 is a diagrammatic view of a flying UAV device, such as drone 100, surrounded by debris 202, in accordance with aspects of the present disclosure. FIG. 2 illustrates the drone 100 moving at elevated position. As noted above, prop wash from drone's propellers may generate debris in the air, such as, but not limited to papers 202 and/or other materials that may obstruct the air propulsion system. To detect debris 202, the drone 100 may be configured to monitor airflow generated by an air propulsion system to detect one or more air flow anomalies indicating potentially blocked air flow, and/or to obtain and analyze an image of the surroundings near the air propulsion system. In an example, the drone 100 may include one or more airflow sensors to detect one or more airflow anomalies indicative of debris 202 affecting the air propulsion system. The one or more sensors may include, but are not limited to, an air pressure sensor or an air velocity sensor arranged within the UAV, wherein the air pressure sensor is configured to detect a current air pressure at one propeller of the multi propeller system that is less than a pressure threshold, and wherein the air velocity sensor is configured to detect a current air velocity at one propeller of the multi propeller system that is less than a velocity threshold. In an alternative or additional aspect, to obtain and analyze an image, the drone 100 may utilize the video system 165 having vision sensors (e.g., cameras), sound sensors, ultrasonic sensors and infrared sensors, as well as corresponding analytics algorithms to detect when a sensed metric meets a condition that indicates one or more airflow anomalies indicative of debris 202 affecting the air propulsion system. Sound sensors (e.g. microphones) may optionally allow the drone 100 to hear speech and environmental sounds, recognize objects and determine properties of the objects. Ultrasonic sensors may measure speed and distances to surrounding objects. In an aspect, infrared sensors may provide thermal imaging. Vision sensors may enable omnidirectional imaging (360-degree) high definition video capture. Vision sensors may include one or more cameras, such as a vertical view camera, front view camera, hidden, and/or retractable camera system that can be housed within the drone 100 body.

The drone 100 may be configured with a rangefinder system, which may be a part of the obstacle avoidance controller 175, to determine the relative distances between the drone 100 and other objects. The rangefinder system may be configured to use, for example, a Laser, Radar, ultrasonic rangefinder, other rangefinding systems or a combination of different rangefinders. The rangefinding system may be configured to scan its field of view and provide range and bearing data for processing. The ultrasonic rangefinder systems use sound propagation through the air to determine distances. The active ultrasonic rangefinder generates a sound beam and listens for its reflections. The time of the transmission of the pulse to its reception is measured end converted to distance by knowing the speed of sound through air. Ultrasonic rangefinders may generate different beam angles with a narrow beam angle being better for detecting objects at long distances and a wide beam angle being better for detecting objects at short distances.

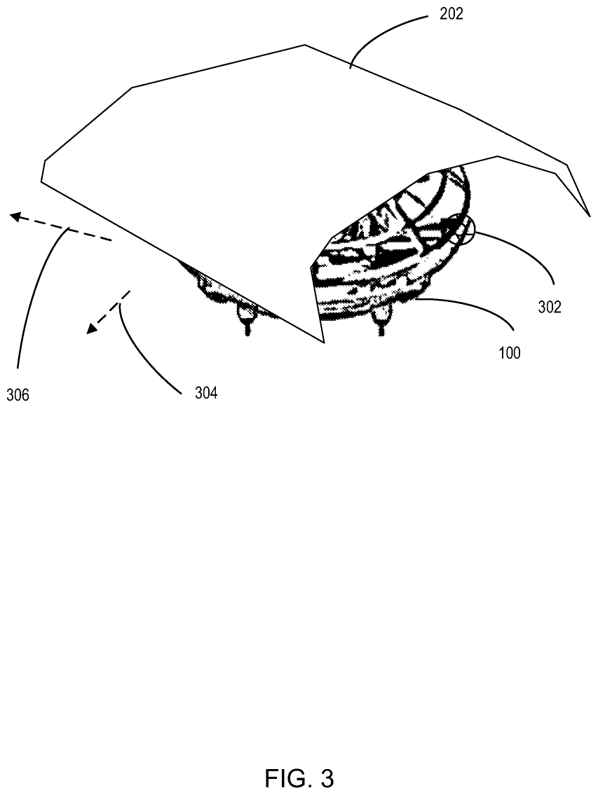

FIG. 3 is a diagrammatic view of a flying UAV device, such as drone, configured to detect air flow anomalies, in accordance with aspects of the present disclosure. To detect air flow anomalies, the drone 100 may include one or more air flow sensors 302 capable of sensing an air flow rate and/or air pressure. In general, an air flow rate is represented as the ratio of a volume of air flowing through a predetermined sectional area with respect to time. The air flow rate can be measured by using measurement apparatuses such as, but not limited to, a differential pressure flowmeter, a rotameter, a magnetic flowmeter, a thermal flowmeter, a vortex flowmeter, an ultrasonic flowmeter, and a mass flowmeter. In an aspect, the air flow sensor 302 may be configured to detect the flow of the air in both the forward and reverse directions relative to air intake or inlet. In an aspect, one or more air flow sensors 302 may be located within a duct or tunnel or other structure housing the propellers of the drone 100. In an aspect, the air flow sensors 302 may include a pressure sensor that generates a signal indicative of an air pressure proximate one or more propellers of UAV, such as one or more propellers of the drone 100. In some examples, the pressure sensor may be configured to determine whether the pressure has increased by a threshold amount relative to an air pressure determined when drone 100 was known to be in normal flight.

As shown in FIG. 3, an air flow anomaly, e.g., an interruption, reduction, or blockage of air flow, may be caused by debris 202 flying in close proximity to the drone 100. In particular, the air flow anomaly may be caused by the debris 202 being located near and/or covering an inlet area adjacent to the air propulsion system (e.g., rotor), such as the area above the rotor in the example illustrated in FIG. 3. In this case, in one example, the air flow sensor 302 may detect a change in air flow that exceeds a predefined threshold. In some alternative or additional cases, the air flow sensor 302 may also determine that the air flow anomaly exists despite, or in combination with, the propellers of the drone 100 spinning at a controlled rate. In an aspect, in response to detecting the change in the air flow, the error detection circuit 120 may send a notification (alert) signal to the flight controller 115.

In an aspect, the navigation circuit 160 of the drone 100 may be configured to keep track of the flying trajectory 304, or heading or route, of the drone 100 and/or compare it to a predetermined flying trajectory 306 configured to lead the drone 100 to a destination. The flying trajectory 304 may be defined by a list of 3 dimensional (3D) coordinate points. The 3D coordinate points may be associated to a timeline and define a list of waypoints. The list may be, for example, in the form of a file. In an aspect, the list may be in the form of a file that is marked up in the Extensible Markup Language (XML). In an aspect, in addition to a number of sets of 3D coordinates values Xᵢ, Yᵢ, Zᵢ, the list may further include a number of orientation angle values (pi. Each set of 3D coordinates values Xᵢ, Yᵢ, Zᵢ may define a waypoint. Each orientation angle value (pi may be associated to one set of 3D coordinates values Xᵢ, Yᵢ, Zᵢ, i.e., to one waypoint. This allows to further define, for each waypoint, the orientation of the flying drone 100 with respect to the vertical axis Z, and thus to enhance the positioning accuracy of the flying drone 100. In an aspect, the timeline may be implemented by adding to each set of 3D coordinates values Xᵢ, Yᵢ, Zᵢ a time ti. Each time ti thus may be associated to one set of 3D coordinates values Xᵢ, Yᵢ, Zᵢ and to one orientation angle value φᵢ.

In an aspect, in response to receiving the alert signal from the error detection circuit 120 (e.g., in response to detection of the air flow anomaly), the flight controller 115 may send a request to the navigation circuit 160 to record the flying trajectory 304 of the drone 100 at that particular time instance, which may deviate from a last known stable flight position, for example, corresponding to the predetermined flying trajectory 306. In an aspect, the current flying trajectory information (e.g., current flying trajectory 304) and prior flying trajectory information corresponding to a last known stable flight position (e.g.; predetermined flying trajectory 306) may include, but is not limited to, motor inputs, height, pitch, roll, heading, position, altitude, high-precision absolute and relative location. This information may be utilized by the flight controller 115 to send out new control commands to account for the air flow anomaly affecting the predetermined flying trajectory 306 of the drone 100.

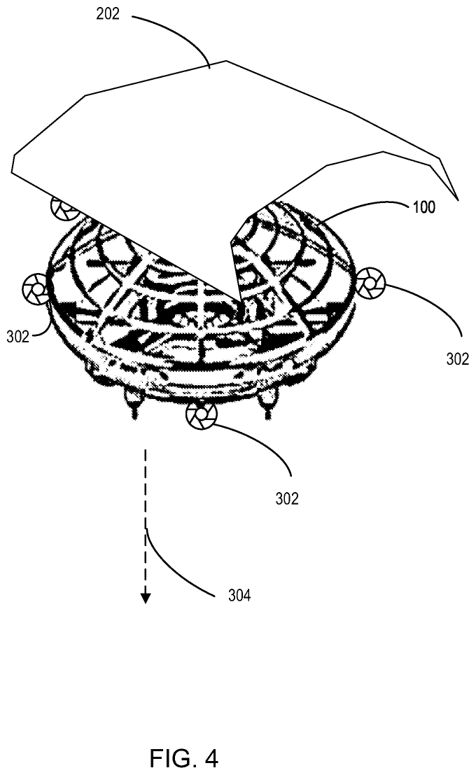

FIG. 4 is a diagram illustrating the drone 100 taking a corrective action, in response to detecting air flow anomalies, to prevent uncontrolled descent in accordance with aspects of the present disclosure. In some aspects, in response to receiving the alert signal from the error detection circuit 120, the flight controller 115 may utilize the cut-off circuit 155 to temporarily “stop” the drone by temporarily activating an onboard “stop” switch, for example. When the on board “stop” switch is activated, the “stop” switch may temporarily stop the drone 100, that is, temporarily stop operation of one or more lift mechanisms of the drone, e.g., commanding motors of the drone to brake (e.g., commanding the motors to free spin, to actively brake, or substituting a throttle signal to the lift mechanism with a zero throttle command) until the flying debris 202 are cleared. For example, if the drone 100 is equipped with four propellers, the on board “stop” switch may deactivate two of the four propeller drive motors on one side of the drone 100.

In an alternative or additional aspect, the flight controller 115 may automatically apply a reverse or rearward, e.g., outlet to inlet, thrust or operation of the rotor as a form of corrective action. When reverse or rearward thrust is applied, in some cases, the drone 100 may transition to a “dive” position illustrated in FIG. 4, e.g., where the current flying trajectory 304 has at least a downward direction component. This may occur as a result of the reverse thrust having a vertical component that pulls the drone 100 downward. Moreover, the reverse operation of the rotor (or other air propulsion system component) will cause air to move from the outlet to the inlet of the rotor, therefore applying a force to the debris 202 to move the debris 202 away from the inlet area. Such a transition may cause the drone 100 to separate from the debris 202 in order to restore the air flow through the rotating propeller(s) to similar state as prior to encountering the debris 202. In alternative or additional aspects, the reverse operation may be applied at a relatively high frequency, e.g., to provide pulsing forces to move the debris 202. In a further alternative or additional aspect, the reverse operation may be applied in combination with rotor operation controls configured to move the drone 100 laterally, e.g., to push the debris 202 away from the inlet area and also to move the drone 100 laterally from the debris 202.

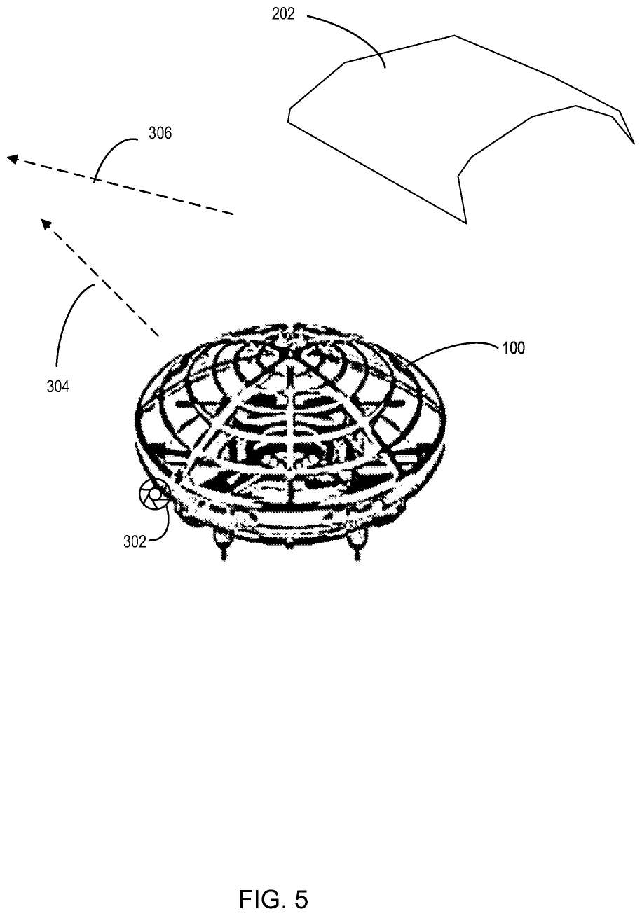

FIG. 5 is a diagram illustrating the drone 100 automatically returning to the predetermined flying trajectory 306 after taking the corrective action, in accordance with aspects of the present disclosure. As shown in FIG. 5, the drone 100 may be configured to automatically separate the drone 100 from the debris 202 in order to restore the air flow produced by the rotating propeller(s) prior to encountering the debris 202. Next, the flight controller 115 may automatically return the drone 100 to the predetermined flying trajectory 306 by adjusting the current flying trajectory 304 based on the flying trajectory information recorded by the flight controller 115. After returning to the predetermined flying trajectory 306, the flight controller 115 may navigate the drone 100 to an original flight destination.

In an aspect, the methods for detection and recovery of blocked air flow described above may also be utilized in various types of fans, such as ducted fans including components of a HVAC system, for example.

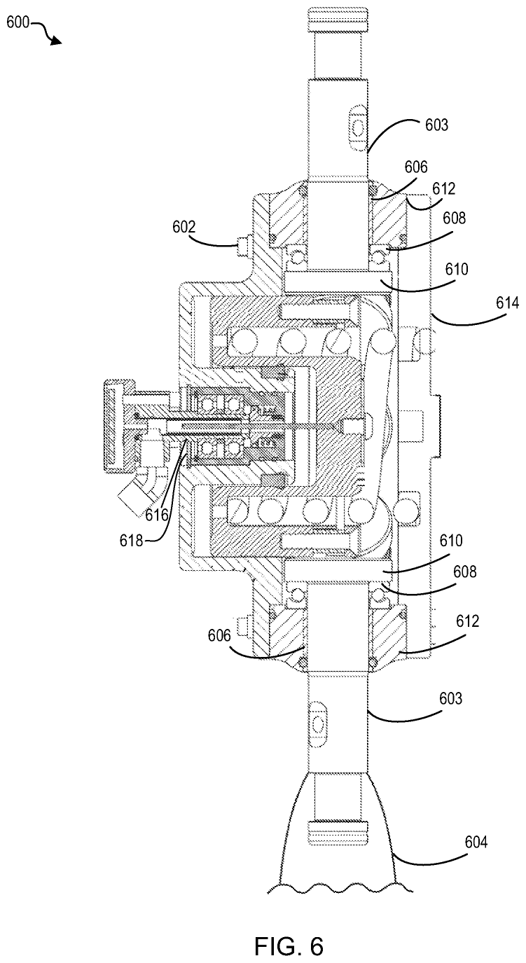

Referring to FIG. 6, for example, an exemplary aspect of a compact variable pitch fan 600 may include one or more components, similar to those described above, that cause the fan 600 to reverse an air flow operation when debris is detected in order to clear the debris from an inlet of the fan. In this example, the variable pitch fan 600 has a peripheral hub 602 in which blade shafts 603 of fan blades 604 are journaled and extend outward in conventional fashion. For each fan blade 604, a bushing 606 and bearings 608 allow the fan blade 604 to rotate at least partially around a radially extending axis passing through the fan blade 604. The fan blade 604 terminates radially inward in a fan blade connector piece 610. The fan blade 604 will typically rotate between normal pitch (e.g., for inlet to outlet air flow) and reverse pitch (e.g., for outlet to inlet air flow), and pass through a continuous range of possible positions between normal and reverse, including a neutral position in which the fan blades 604 are parallel to the plane of rotation of the fan blades 604. Attached to a back side 612 of the peripheral hub 602 by any suitable means is a back or mounting plate 614. The mounting plate 614 permits the variable pitch fan 600 to be mounted directly on a rotating part of an engine (not shown), typically of a piece of heavy machinery, so that the entire variable pitch fan rotates together, apart from a rotary union 616.

During operation, it is sometimes useful to know air flow rate or pressure and the exact position of the fan blades 604. In an aspect, the air flow sensors 618 may be employed to detect debris in the vicinity of the fan 600. The air flow sensors 618 may be the same as or similar to the air flow sensor 302 described above. For example, the air flow sensor 618 may detect a change in air flow rate or pressure that exceeds a predefined threshold, and in some cases in combination with detecting that the fan blades 604 are spinning and have a normal pitch. In an aspect, the air flow sensor 618 may be configured to detect the flow of the air in both the forward and reverse directions relative to air intake or inlet. In an aspect, in response to detecting the change in the air flow (i.e., air flow anomalies indicating potentially blocked air flow), the air flow sensor 618 may send a notification (alert) signal to a controller (not shown). In one aspect shown in FIG. 6, the air flow sensors 618 may be incorporated at least partly within the rotary union 616.

Sensor signals from the air flow sensor 618 may be sent to the controller of the fan 600. The controller of the fan 600 can be a dedicated electronic device, or a virtual device: an existing programmable controller can be programmed to directly control the fan blades 604. In response to receiving the notification signal, the controller of the fan 600 may change the pitch of the fan blades 604 towards full reverse thrust in an attempt to blow any debris away from an inlet of the fan blade(s) 604 prior to returning to its normal operation. The air flow sensor 618 may continue measuring the air flow to determine if the air flow anomaly still exists, and if so, repeat the above process. Alternatively, or in addition, in response to receiving the notification signal, the controller of the fan 600 may simply stop the fan blades 604 and wait for a predetermined period of time before restarting.

After determining that the one or more air flow anomalies are resolved, it may be desirable to return the fan blades 604 to the position the fan blades 604 were in prior to the detection of the debris. Accordingly, in response to resolving the detected air flow anomalies, the controller of the fan 600 may return the fan blades 604 to the position the fan blades 604 were in prior to the detection of the air flow anomaly.

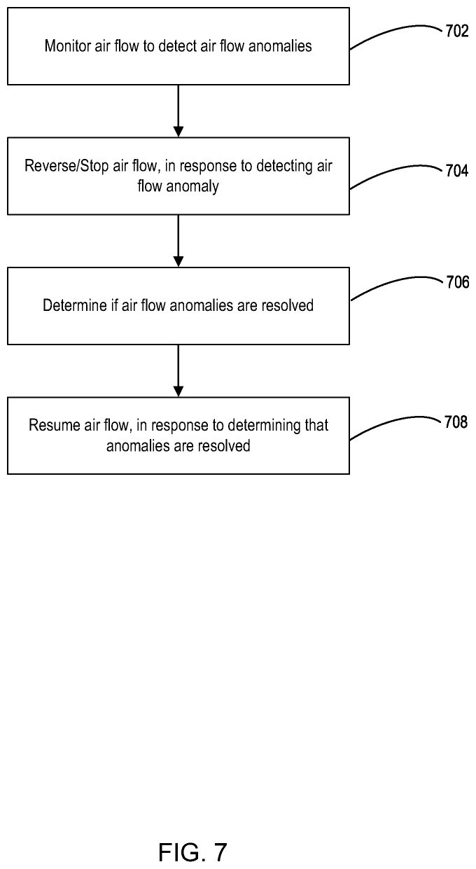

FIG. 7 is an example of a flowchart illustrating a method 700 for detection of blocked air flow. FIGS. 1-6 may be referenced in combination with the flowchart of FIG. 7.

At step 702, airflow generated by an air propulsion system may be monitored to detect one or more air flow anomalies indicating potentially blocked air flow. In one aspect, the air propulsion system may include various components of an HVAC system. Such components may include, for example, the variable pitch fan 600 shown in FIG. 6. In one aspect shown in FIG. 6, the air flow rate sensors 618 may be incorporated at least partly within the rotary union 616. In an aspect, the air flow sensor 618 may be configured to detect the flow of the air in both the forward and reverse directions relative to air intake. In another aspect, the air propulsion system may be a component of a UAV, such as a drone 100 shown in FIGS. 1-6 As shown in FIG. 3, air flow anomaly may be caused by debris 202 flying in close proximity to the drone 100. In this case, the air flow sensor 302 may detect a change in air flow rate that exceeds a predefined threshold, despite the propellers of the drone 100 spinning at a constant rate.

At step 704, in response to detecting the one or more air flow anomalies, the airflow generated by the air propulsion system may be automatically reversed or stopped temporarily. For example, in response to receiving the notification signal, the controller of the fan 600 may change the pitch of the fan blades 604 towards full reverse thrust in an attempt to blow the debris away prior to returning to its normal operation. The air flow sensor 618 may continue measuring the air flow rate to determine if the air flow anomaly still exists. With respect to the drone 100, the flight controller 115 may automatically apply a reverse or rearward thrust as a form of corrective action. When reverse or rearward thrust is applied, the drone 100 may transition to the “dive” position illustrated in FIG. 4. This may occur as a result of the reverse thrust having a vertical component that pulls the vehicle downward. Such a transition may cause the drone 100 to separate from the debris 202 in order to restore the air flow rate produced by the rotating propellers prior to encountering the debris 202. For example, the cut-off circuit 155 may disable or stop the motors momentarily, in response to detection of an air flow anomaly or a similar error so that detected debris can be cleared automatically. The cut-off circuit 155 may include a “stop” switch, that may be triggered when the error detection circuit 120 detects an air flow anomaly.

At step 706, the air propulsion system may determine whether the one or more detected air flow anomalies are resolved by the reversed or stopped air flow. For example, the air flow sensor 618 may continue measuring the air flow rate to determine if the air flow anomaly still exists when the pitch of the fan blades 604 is changed to full reverse thrust. In an aspect, the drone 100 may also determine whether the one or more detected air flow anomalies are resolved. Ultrasonic sensors may measure speed and distances to surrounding objects. Vision sensors may enable omnidirectional imaging (360-degree) high definition video capture. In an aspect, infrared sensors provide thermal imaging. The vision sensors may include one or more cameras, such as a vertical view camera, front view camera, hidden, and/or retractable camera system that can be housed within the drone 100 body. The drone 100 may be configured with a rangefinder system to determine the relative distances between the drone 100 and other objects. The rangefinder system may be configured to use, for example, a Laser, Radar, ultrasonic rangefinder, other rangefinding systems or a combination of different rangefinders. The rangefinding system may be configured to scan its field of view and provide range and bearing data for processing. The ultrasonic rangefinder systems may use sound propagation through the air to determine distance. In an aspect, the flight controller 115 may employ a previously trained Artificial Intelligence (AI) system. Such AI system may be configured to detect one or more obstacles based on visual data that is pre-learned using machine learning.

At step 708, in response to determining that the one or more air flow anomalies are resolved, the airflow generated by the air propulsion system prior to the detection of the one or more air flow anomalies may be resumed. For example, in response to resolving the detected air flow anomalies, the controller of the fan 600 may return the fan blades 604 to the position that the fan blades 604 were in prior to the detection of the air flow anomaly. FIG. 5 is a diagram illustrating the drone 100 automatically returning to the last known stable flight position after taking the corrective action, in accordance with aspects of the present disclosure. As shown in FIG. 5, the drone 100 may be configured to automatically separate the drone 100 from the debris 202. Next, the flight controller 115 may automatically return the drone 100 to the last known stable flight position based on the flying trajectory information recorded by the flight controller 115. In an aspect, the flight controller 115 may automatically return the drone 100 to the last known stable flight position based flying trajectory information. As noted above, the flying trajectory information may include, but is not limited to, motor inputs, height, pitch, roll, heading, position, altitude, high-precision absolute and relative location. After returning to the last known stable flight position, the flight controller 115 may navigate the drone to an original flight destination.

Advantageously, various aspects disclosed herein provide autonomous recovery from detected air flow anomalies. The disclosed system may be used with .any type of air propulsion/air flow system, including, but not limited to UAVs, HVAC systems, and the like.

In other words, a method 700 for detection of blocked air flow includes monitoring airflow generated by an air propulsion system to detect one or more air flow anomalies indicating potentially blocked air flow. In response to detecting the one or more air flow anomalies, the airflow generated by the air propulsion system may be automatically reversed or temporarily stopped. A determination may be made whether the one or more detected air flow anomalies are resolved by the reversed or stopped air flow. The airflow generated by the air propulsion system prior to the detection of the one or more air flow anomalies may be resumed, in response to determining that the one or more air flow anomalies are resolved.

In one or any combination of these aspects, the air propulsion system comprises a multi propeller system of an Unmanned Aerial Vehicle (UAV).

In one or any combination of these aspects, the one or more air flow anomalies are detected by an air pressure sensor or an air velocity sensor arranged within the UAV, wherein the air pressure sensor is configured to detect a current air pressure at one propeller of the multi propeller system that is less than a pressure threshold, and wherein the air velocity sensor is configured to detect a current air velocity at one propeller of the multi propeller system that is less than a velocity threshold.

In one or any combination of these aspects, the method further includes, in response to detecting the one or more air flow anomalies, determining if a current deviation of a current position and/or orientation from a planned position and/or orientation is more than a deviation threshold and adjusting an operating setting of at least one propeller of the multi propeller system by a correction amount configured to reduce a future deviation of a future position and/or orientation to be less than the deviation threshold.

In one or any combination of these aspects, the method further includes avoiding obstacles when adjusting the current position and/or orientation of the UAV.

In one or any combination of these aspects, detecting the one or more air flow anomalies includes detecting a reduced air flow and identifying an object adjacent to an air inlet in an image.

In one or any combination of these aspects, the method further includes determining whether the one or more detected air flow anomalies are resolved based on measured air flow meeting an air flow threshold and/or based on an image of air inlet being clear of any object adjacent to the inlet.

In one or any combination of these aspects, the air propulsion system includes a Heating Ventilating and Air Conditioning (HVAC) system.

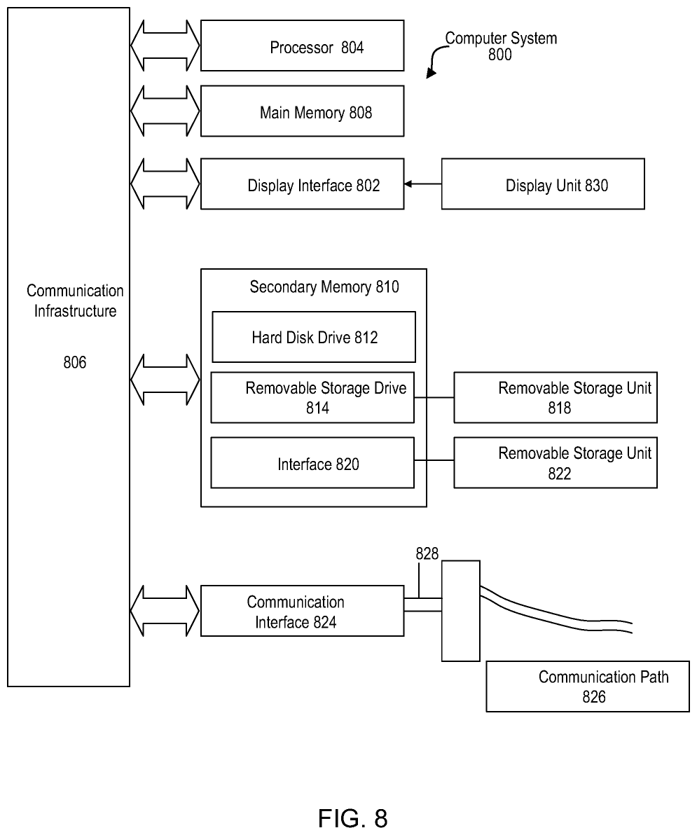

Aspects of the present disclosure may be implemented using hardware, software, or a combination thereof and may be implemented in one or more computer systems or other processing systems. In one aspect, the disclosure is directed toward one or more computer systems capable of carrying out the functionality described herein. FIG. 8 is an example of a block diagram illustrating various hardware components and other features of a computer system that may operate the drone 100 in accordance with aspects of the present disclosure. Aspects of the present disclosure may be implemented using hardware, software, or a combination thereof and may be implemented in one or more computer systems or other processing systems. In one example variation, aspects of the disclosure are directed toward one or more computer systems capable of carrying out the functionality described herein. An example of such a computer system 800 is shown in FIG. 8.

Computer system 800 includes one or more processors, such as processor 804. The processor 804 is connected to a communication infrastructure 806 (e.g., a communications bus, cross-over bar, or network). Various software aspects are described in terms of this example computer system. After reading this description, it will become apparent to a person skilled in the relevant art(s) how to implement aspects of the disclosure using other computer systems and/or architectures.

Processor 804, or any other “processor,” as used herein, processes signals and performs general computing and arithmetic functions. Signals processed by the processor may include digital signals, data signals, computer instructions, processor instructions, messages, a bit, a bit stream, or other computing that may be received, transmitted and/or detected.

Communication infrastructure 806, such as a bus (or any other use of “bus” herein), refers to an interconnected architecture that is operably connected to transfer data between computer components within a singular or multiple systems. The bus may be a memory bus, a memory controller, a peripheral bus, an external bus, a crossbar switch, and/or a local bus, among others. The bus may also be a bus that interconnects components inside a access control system using protocols, such as Controller Area network (CAN), Local Interconnect Network (LIN), Wiegand and Open Supervised Device Protocol (OSDP) among others.

Further, the connection between components of computer system 800, or any other type of connection between computer-related components described herein can be referred to an operable connection, and can include a connection by which entities are operably connected, such that signals, physical communications, and/or logical communications can be sent and/or received. An operable connection can include a physical interface, a data interface and/or an electrical interface.

Computer system 800 can include a display interface 802 that forwards graphics, text, and other data from the communication infrastructure 806 (or from a frame buffer not shown) for display on a display unit 830. Computer system 800 also includes a main memory 808, preferably random access memory (RAM), and can also include a secondary memory 810. The secondary memory 810 can include, for example, a hard disk drive 812 and/or a removable storage drive 814, representing a floppy disk drive, a magnetic tape drive, an optical disk drive, etc. The removable storage drive 814 reads from and/or writes to a removable storage unit 818 in a well-known manner. Removable storage unit 818, represents a floppy disk, magnetic tape, optical disk, etc., which is read by and written to removable storage drive 814. As will be appreciated, the removable storage unit 818 includes a computer usable storage medium having stored therein computer software and/or data.

In alternative aspects, secondary memory 810 can include other similar devices for allowing computer programs or other instructions to be loaded into computer system 800. Such devices can include, for example, a removable storage unit 822 and an interface 820. Examples of such can include a program cartridge and cartridge interface (such as that found in video game devices), a removable memory chip (such as an erasable programmable read only memory (EPROM), or programmable read only memory (PROM)) and associated socket, and other removable storage units 822 and interfaces 820, which allow software and data to be transferred from the removable storage unit 822 to computer system 800.

It should be understood that a memory, as used herein can include volatile memory and/or non-volatile memory. Non-volatile memory can include, for example, ROM (read only memory), PROM (programmable read only memory), EPROM (erasable PROM) and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and/or direct RAM bus RAM (DRRAM).

Computer system 800 can also include a communications interface 824. Communications interface 824 allows software and data to be transferred between computer system 800 and external devices. Examples of communications interface 824 can include a modem, a network interface (such as an Ethernet card), a communications port, a Personal Computer Memory Card International Association (PCMCIA) slot and card, etc. Software and data transferred via communications interface 624 are in the form of signals 828, which can be electronic, electromagnetic, optical or other signals capable of being received by communications interface 824. These signals 828 are provided to communications interface 824 via a communications path (e.g., channel) 826. This path 826 carries signals 828 and can be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 814, a hard disk installed in hard disk drive 812, and signals 828. These computer program products provide software to the computer system 800. Aspects of the disclosure are directed to such computer program products.

Computer programs (also referred to as computer control logic) are stored in main memory 808 and/or secondary memory 810. Computer programs can also be received via communications interface 824. Such computer programs, when executed, enable the computer system 800 to perform various features in accordance with aspects of the present disclosure, as discussed herein. In particular, the computer programs, when executed, enable the processor 804 to perform such features. Accordingly, such computer programs represent controllers of the computer system 800.

In variations where aspects of the disclosure are implemented using software, the software can be stored in a computer program product and loaded into computer system 800 using removable storage drive 814, hard drive 812, or communications interface 820. The control logic (software), when executed by the processor 804, causes the processor 804 to perform the functions in accordance with aspects of the disclosure as described herein. In another variation, aspects are implemented primarily in hardware using, for example, hardware components, such as application specific integrated circuits (ASICs). Implementation of the hardware state machine so as to perform the functions described herein will be apparent to persons skilled in the relevant art(s).

In yet another example variation, aspects of the disclosure are implemented using a combination of both hardware and software.

The aspects of the disclosure discussed herein can also be described and implemented in the context of computer-readable storage medium storing computer-executable instructions. Computer-readable storage media includes computer storage media and communication media. For example, flash memory drives, digital versatile discs (DVDs), compact discs (CDs), floppy disks, and tape cassettes. Computer-readable storage media can include volatile and nonvolatile, removable and non-removable media implemented in any method or technology for storage of information such as computer readable instructions, data structures, modules or other data.

It will be appreciated that various implementations of the above-disclosed and other features and functions, or alternatives or varieties thereof, can be desirably combined into many other different systems or applications. Also that various presently unforeseen or unanticipated alternatives, modifications, variations, or improvements therein can be subsequently made by those skilled in the art which are also intended to be encompassed by the following claims.

What is claimed is:

1. A method for detection of blocked air flow, comprising:
monitoring airflow generated by an air propulsion system to detect one or more air flow anomalies indicating potentially blocked air flow;
automatically reversing or temporarily stopping the airflow generated by the air propulsion system, in response to detecting the one or more air flow anomalies;
determining whether the one or more detected air flow anomalies are resolved by the reversed or stopped air flow; and
resuming the airflow generated by the air propulsion system prior to the detection of the one or more air flow anomalies, in response to determining that the one or more air flow anomalies are resolved.

2. The method of claim 1, wherein the air propulsion system comprises a multi propeller system of an Unmanned Aerial Vehicle (UAV).

3. The method of claim 2, wherein the one or more air flow anomalies are detected by an air pressure sensor or an air velocity sensor arranged within the UAV, wherein the air pressure sensor is configured to detect a current air pressure at one propeller of the multi propeller system that is less than a pressure threshold, and wherein the air velocity sensor is configured to detect a current air velocity at one propeller of the multi propeller system that is less than a velocity threshold.

4. The method of claim 2, further comprising, in response to detecting the one or more air flow anomalies, determining if a current deviation of a current position and/or orientation from a planned position and/or orientation is more than a deviation threshold and adjusting an operating setting of at least one propeller of the multi propeller system by a correction amount configured to reduce a future deviation of a future position and/or orientation to be less than the deviation threshold.

5. The method of claim 4, further comprising avoiding obstacles when adjusting the current position and/or orientation of the UAV.

6. The method of claim 1, wherein detecting the one or more air flow anomalies includes detecting a reduced air flow and identifying an object adjacent to an air inlet in an image.

7. The method of claim 1, further comprising determining whether the one or more detected air flow anomalies are resolved based on measured air flow meeting an air flow threshold and/or based on an image of an air inlet being clear of any object adjacent to the inlet.

8. The method of claim 1, wherein the air propulsion system comprises a Heating Ventilating and Air Conditioning (HVAC) system.

9. An air propulsion system of an Unmanned Aerial Vehicle (UAV), comprising:
a hardware processor configured to:
monitor airflow generated by an air propulsion system to detect one or more air flow anomalies indicating potentially blocked air flow;
automatically reverse or temporarily stop the airflow generated by the air propulsion system, in response to detecting the one or more air flow anomalies;
determine whether the one or more detected air flow anomalies are resolved by the reversed or stopped air flow; and
resume the airflow generated by the air propulsion system prior to the detection of the one or more air flow anomalies, in response to determining that the one or more air flow anomalies are resolved.

10. The system of claim 9, wherein the air propulsion system comprises a multi propeller system.

11. The system of claim 9, wherein the one or more air flow anomalies are detected by an air pressure sensor or an air velocity sensor arranged within the UAV, wherein the air pressure sensor is configured to detect a current air pressure at one propeller of the multi propeller system that is less than a pressure threshold, and wherein the air velocity sensor is configured to detect a current air velocity at one propeller of the multi propeller system that is less than a velocity threshold.

12. The system of claim 9, wherein in response to detecting the one or more air flow anomalies, the hardware processor is further configured to determine if a current deviation of a current position and/or orientation from a planned position and/or orientation is more than a deviation threshold and configured to adjust an operating setting of at least one propeller of the multi propeller system by a correction amount configured to reduce a future deviation of a future position and/or orientation to be less than the deviation threshold.

13. The system of claim 12, wherein the hardware processor is further configured to avoid obstacles when adjusting the current position and/or orientation of the UAV.

14. The system of claim 9, wherein the hardware processor configured to detect the one or more air flow anomalies is further configured to detect a reduced air flow and identify an object adjacent to an air inlet in an image.

15. The system of claim 9, wherein the hardware processor is further configured to determine whether the one or more detected air flow anomalies are resolved based on measured air flow meeting an air flow threshold and/or based on an image of air inlet being clear of any object adjacent to the inlet.

16. The system of claim 9, wherein the air propulsion system comprises a Heating Ventilating and Air Conditioning (HVAC) system.

17. An air propulsion system of a Heating Ventilating and Air Conditioning (HVAC) system, comprising:
a hardware processor configured to:
monitor airflow generated by an air propulsion system to detect one or more air flow anomalies indicating potentially blocked air flow;
automatically reverse or temporarily stop the airflow generated by the air propulsion system, in response to detecting the one or more air flow anomalies;
determine whether the one or more detected air flow anomalies are resolved by the reversed or stopped air flow; and
resume the airflow generated by the air propulsion system prior to the detection of the one or more air flow anomalies, in response to determining that the one or more air flow anomalies are resolved.

18. The system of claim 17, wherein the air propulsion system comprises a variable pitch fan.

19. The system of claim 18, wherein the one or more air flow anomalies are detected by an air pressure sensor or an air velocity sensor arranged within the variable pitch fan.

20. The system of claim 18, wherein the one or more air flow anomalies are detected by an air pressure sensor by detecting a change in air flow rate that exceeds a predefined threshold.
